(19) United States
(12) Patent Application Publication
(10) Pub. No.: US 2026/0229565 A1
(43) Pub. Date: Aug. 6, 2026

(54) FUEL CELL CONTROL SYSTEM AND METHOD FOR ADJUSTING OPERATION IN RESPONSE TO LOW PURITY HYDROGEN FUEL

(71) Applicant: GM GLOBAL TECHNOLOGY OPERATIONS LLC, Detroit, MI (US)

(72) Inventors: Jie KOU, Novi, MI (US); Xiaofeng Wang, Troy, MI (US); Steven Falta, Honeoye Falls, NY (US)

(21) Appl. No.: 19/046,583

(22) Filed: Feb. 6, 2025

(51) Int. Cl. H01M 8/04746; H01M 4/86; H01M 8/04082; H01M 8/0444; H01M 8/04537; H01M 8/10; H01M 8/1004

(52) U.S. Cl. CPC H01M 8/04753; H01M 4/8605; H01M 8/04201; H01M 8/04447; H01M 8/04574; H01M 8/1004; H01M 2008/1095; H01M 2250/20

(57) ABSTRACT

A fuel cell system includes a fuel cell stack including an anode electrode, a first gas diffusion layer arranged adjacent to the anode electrode and defining an anode volume, a cathode electrode, a second gas diffusion layer arranged adjacent to the cathode electrode, and a proton exchange membrane (PEM) arranged between the anode electrode and the cathode electrode. One or more hydrogen injectors configured to inject hydrogen fuel into the first gas diffusion layer. A bleed valve is in fluid communication with the anode volume of the first gas diffusion layer. A controller is configured to receive a hydrogen purity of the hydrogen fuel and to at least one of selectively reduce a maximum output power of the fuel cell stack and increase flow through the bleed valve in response to changes in the hydrogen purity.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fuel cells, and more particularly to a fuel cell controller that adjusts operation in response to hydrogen fuel purity.

Fuel cells can be used to provide power to a load. The load can include a battery system of an electric vehicle and/or other types of loads for mobile or stationary applications. Fuel cells typically include anode electrodes, cathode electrodes, and a proton exchange membrane (also referred to as a polymer electrolyte membrane) (PEM). The PEM is arranged between the cathode and anode electrodes.

Molecular hydrogen (H₂) is supplied to the anode electrode and air (including molecular oxygen (O₂)) is supplied to the cathode electrode. Hydrogen ions (H⁺) from the molecular hydrogen pass through the PEM and electrons (e⁻) pass through the load connected across the anode and cathode electrodes. The hydrogen ions, electrons, and oxygen recombine at the cathode electrode and form water.

### SUMMARY

A fuel cell system including a fuel cell stack including an anode electrode, a first gas diffusion layer arranged adjacent to the anode electrode, a cathode electrode, a second gas diffusion layer arranged adjacent to the cathode electrode, and a proton exchange membrane (PEM) arranged between the anode electrode and the cathode electrode. One or more hydrogen injectors are configured to inject hydrogen fuel into the first gas diffusion layer. A controller is configured to receive a hydrogen purity of the hydrogen fuel and to selectively adjust operation of the fuel cell system in response thereto.

In other features, a hydrogen purity sensor is configured to measure the hydrogen purity of the hydrogen fuel and outputs the hydrogen purity to the controller. The controller receives the hydrogen purity from an external source. The controller includes a maximum current density calculating module configured to calculate a maximum current density. The controller includes a maximum impurity calculating module configured to calculate a maximum impurity of the hydrogen fuel.

In other features, the controller includes a maximum power adjusting module configured to adjust a maximum output power of the fuel cell stack in response to at least one of the maximum current density and the maximum impurity of the hydrogen fuel. A bleed valve is in fluid communication with an anode volume. The controller includes a bleed valve adjusting module configured to adjust flow through the bleed valve in response to at least one of the maximum current density and the maximum impurity of the hydrogen fuel.

In other features, the controller includes a maximum power adjusting module configured to selectively adjust a maximum output power of the fuel cell stack in response to at least one of the maximum current density and the maximum impurity of the hydrogen fuel and a bleed valve adjusting module configured to selectively adjust flow through the bleed valve in response to at least one of the maximum current density and the maximum impurity of the hydrogen fuel. A vehicle includes the fuel cell system.

A fuel cell system includes a fuel cell stack including an anode electrode, a first gas diffusion layer arranged adjacent to the anode electrode and defining an anode volume, a cathode electrode, a second gas diffusion layer arranged adjacent to the cathode electrode, and a proton exchange membrane (PEM) arranged between the anode electrode and the cathode electrode. One or more hydrogen injectors configured to inject hydrogen fuel into the first gas diffusion layer. A bleed valve is in fluid communication with the anode volume of the first gas diffusion layer. A controller is configured to receive a hydrogen purity of the hydrogen fuel and to at least one of selectively reduce a maximum output power of the fuel cell stack and increase flow through the bleed valve in response to changes in the hydrogen purity.

In other features, a hydrogen purity sensor is configured to measure the hydrogen purity of the hydrogen fuel and outputs the hydrogen purity to the controller. The controller receives the hydrogen purity from an external source. The controller includes a maximum current density calculating module configured to calculate a maximum current density. The controller includes a maximum impurity calculating module configured to calculate a maximum impurity of the hydrogen fuel. The controller includes a maximum power adjusting module configured to adjust a maximum output power of the fuel cell stack in response to at least one of the maximum current density and the maximum impurity of the hydrogen fuel.

In other features, the controller includes a bleed valve adjusting module configured to adjust flow through the bleed valve in response to at least one of the maximum current density and the maximum impurity of the hydrogen fuel. The controller includes a maximum power adjusting module configured to selectively adjust a maximum output power of the fuel cell stack in response to at least one of the maximum current density and the maximum impurity of the hydrogen fuel. The controller includes a bleed valve adjusting module configured to selectively adjust flow through the bleed valve in response to at least one of the maximum current density and the maximum impurity of the hydrogen fuel. A vehicle includes the fuel cell system.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a fuel cell according to the present disclosure;

FIG. 2 illustrate an example of gas and fluid flows to and from an anode electrode according to the present disclosure;

FIGS. 3A to 3E are functional block diagrams of examples of a controller configured to control a fuel cell system in response to sensed and/or received hydrogen fuel purity according to the present disclosure;

FIG. 4 is a graph illustrating an example of maximum supported impurity percentage as a function of current density;

FIG. 5 is a flowchart of an example of a method for disabling filling of the H₂ storage tank in response to H₂ purity according to the present disclosure;

FIG. 6 is a flowchart of an example of a method for adjusting maximum output power of the fuel cell in response to H₂ purity according to the present disclosure;

FIG. 7 is a flowchart of an example of a method for adjusting maximum output power of the fuel cell in response to measured H₂ purity according to the present disclosure; and

FIG. 8 is a flowchart of an example of a method for adjusting a position of a bleed valve in response to measured H₂ purity according to the present disclosure.

In the drawings, reference numbers may be reused to identify similar and/or identical elements.

### DETAILED DESCRIPTION

While a controller for a fuel cell system according to the present disclosure is described in the context of fuel cell systems for vehicles, the fuel cell system can be used to generate power in other types of mobile or stationary applications.

Fuel cell systems including a proton exchange membrane (or polymer electrolyte membrane) (PEM) require high purity molecular hydrogen (H₂) fuel for optimum performance and durability. When the purity of the H₂ fuel is less than desired, irreversible damage may occur to the fuel cell stack and longevity of the fuel cell stack may be reduced. Fuel cell systems typically include a controller that relies on models that assume that the H₂ fuel has high H₂ purity. As a result, the fuel cell stack is vulnerable to low impurity levels of the H₂ fuel.

In some examples, fuel cell systems according to the present disclosure include a H₂ purity sensor configured to measure the H₂ purity of the H₂ fuel. An example of the H₂ purity sensor is shown and described in commonly-assigned U.S. patent application Ser. No. 19/014,059, filed on Jan. 8, 2025, which is hereby incorporated by reference in its entirety. In some examples, the H₂ purity sensor is located onboard the vehicle including the fuel cell or on a fuel cell assembly in other applications. In other examples, the H₂ purity sensor is located separately from the vehicle including the fuel cell or the fuel cell assembly.

In some examples, when H₂ purity of the H₂ fuel is lower than desired, the controller of the fuel cell adjusts (e.g., reduces) a power output level of the fuel cell, maintains the power output level of the fuel cell and compensates by increasing purging using an anode bleed valve, and/or a combination thereof. In some examples, the controller estimates the minimum acceptable H₂ purity and/or estimates the maximum supportable output power based on the H₂ purity. Allowing the fuel cell to operate with lower purity H₂ fuel provides additional flexibility during operation of the fuel cell system.

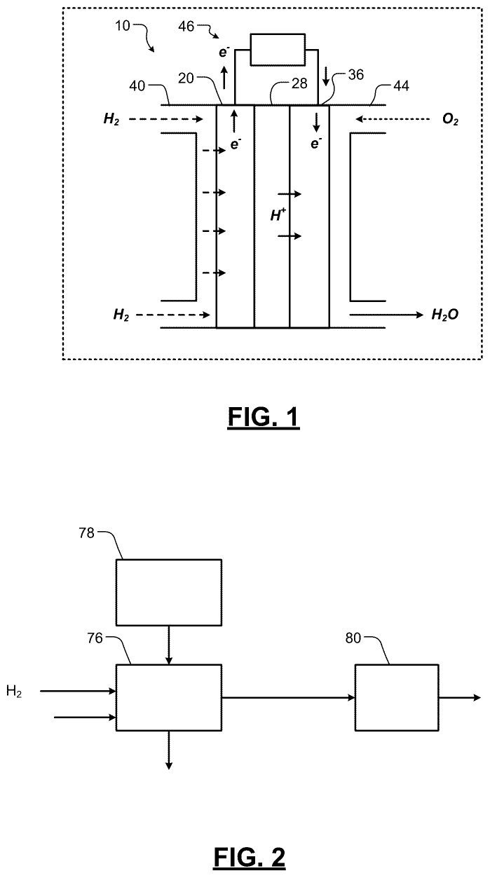

Referring now to FIG. 1, a fuel cell stack 10 includes an anode electrode 20, a membrane 28, and a cathode electrode 36. Gas diffusion layers 40 and 44 are arranged adjacent to the anode electrode 20 and the cathode electrode 36, respectively. Molecular hydrogen (H₂) is supplied to the gas diffusion layer 40 of the anode electrode 20. Molecular oxygen (O₂) is supplied to the gas diffusion layer 44 of the cathode electrode 36. The membrane 28 passes hydrogen ions (H⁺) to the cathode electrode 36. Electrons (e⁻) pass through an external circuit 46 such as a load or a battery to the cathode electrode. The molecular oxygen (O₂) and hydrogen ions (H⁺) form water (H₂O) output by the gas diffusion layer 44.

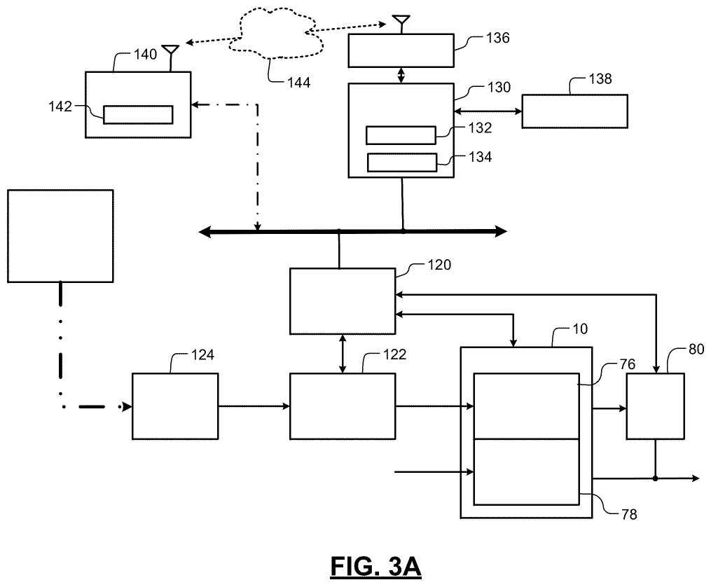

Referring now to FIG. 2, H₂ fuel and an inertia gas (such as molecular nitrogen N₂) are input to an anode volume of the anode 76. N₂ permeation occurs from a cathode volume of the cathode 78 (due to the use of air as the source for molecular O₂). H₂ permeation may occur from the anode 76. A bleed valve 80 can be used to bleed gas flow from the anode 20. A size of the bleed valve 80 determines the flow rate of bleed gas that can be removed from the anode 76 to offset lower purity H₂ fuel when the bleed valve 80 is fully open. The bleed gas flow includes H₂, N₂, and/or water (H₂O) vapor.

The anode mass balance equation and anode N₂ balance equation are as follows:

$${\dot{n}}_{vlv} = {\dot{n}}_{Inj} - {\dot{n}}_{PowerGen} + {\dot{n}}_{N 2 Perm} - {\dot{n}}_{H 2 Perm} \qquad ( 1 )$$

$${\dot{n}}_{vlv} * {Pct}_{N 2 \_ An} = {\dot{n}}_{N 2 Perm} + {\dot{n}}_{Inj} * {Pct}_{Impurity \_ N 2} \qquad ( 2 )$$

$$replacing {\dot{n}}_{Inj} in equation ( 2 ) using equation ( 1 ) :$$

$${\dot{n}}_{vlv} * {Pct}_{N {2}_{An}} = {\dot{n}}_{N 2 Perm} + ( {\dot{n}}_{vlv} - {\dot{n}}_{PowerGen} + {\dot{n}}_{N 2 Perm} - {\dot{n}}_{H 2 Perm} ) * {Pct}_{{Impurity}_{N 2}} \qquad ( 3 )$$

$${\dot{n}}_{PowerGen} = \frac{{\dot{n}}_{vlv} * {Pct}_{N {2}_{An}} - {\dot{n}}_{N 2 Perm}}{{Pct}_{Impurity \_ N 2}} - ( {\dot{n}}_{vlv} - {\dot{n}}_{N 2 Perm} + {\dot{n}}_{H 2 Perm} ) \qquad ( 4 )$$

Where \dot{n}ᵥₗᵥ is the molar flow rate corresponding to flow through the bleed valve, \dot{n}_{Inj} is the molar flow rate from the H₂ injector, \dot{n}_{PowerGen} is the molar flow rate consumed by power generation, \dot{n}_{N2Perm} is the molar flow rate of N₂ permeating from the cathode into the anode, \dot{n}_{H2Perm} is the molar flow rate corresponding to H₂ permeation and leakage loss from the anode, and Pct_{N2_An} is the percentage of N₂ permeation from the cathode.

Maximum current density jₘₐₓ that can be supported is:

$${j}_{max} = \frac{{\dot{n}}_{PowerGen} * 2 F}{{N}_{cell} * {A}_{actv}} \qquad ( 5 )$$

$${j}_{max} = \frac{\frac{{\dot{n}}_{vlv} * {Pct}_{N 2 \_ An} - {\dot{n}}_{N 2 Perm}}{{Pct}_{Impurity \_ N 2}} - ( {\dot{n}}_{vlv} - {\dot{n}}_{N 2 Perm} + {\dot{n}}_{H 2 Perm} )}{{N}_{cell} * {A}_{actv}} * 2 F \qquad ( 6 )$$

Where N_{cell} is the number of fuel cells, A_{actv} is active area of the fuel cells, and F is the Faraday constant. With known maximum current density jₘₐₓ from equation (5), the maximum impurity (Pct_{Impurity_N2}) of the H₂ fuel from the injector is calculated as follows:

$${Pct}_{Impurity \_ N 2} = \frac{{\dot{n}}_{vlv} * {Pct}_{N 2 \_ An} - {\dot{n}}_{N 2 Perm}}{{\dot{n}}_{vlv} + {\dot{n}}_{PowerGen} - {\dot{n}}_{N 2 Perm} + {\dot{n}}_{H 2 Perm}} \qquad ( 7 )$$

$${Pct}_{Impurity \_ N 2} = \frac{{\dot{n}}_{vlv} * {Pct}_{N 2 \_ An} - {\dot{n}}_{N 2 Perm}}{{\dot{n}}_{vlv} + \frac{{j}_{max} * {N}_{cell} * {A}_{actv}}{2 F} - {\dot{n}}_{N 2 Perm} + {\dot{n}}_{H 2 Perm}} \qquad ( 8 )$$

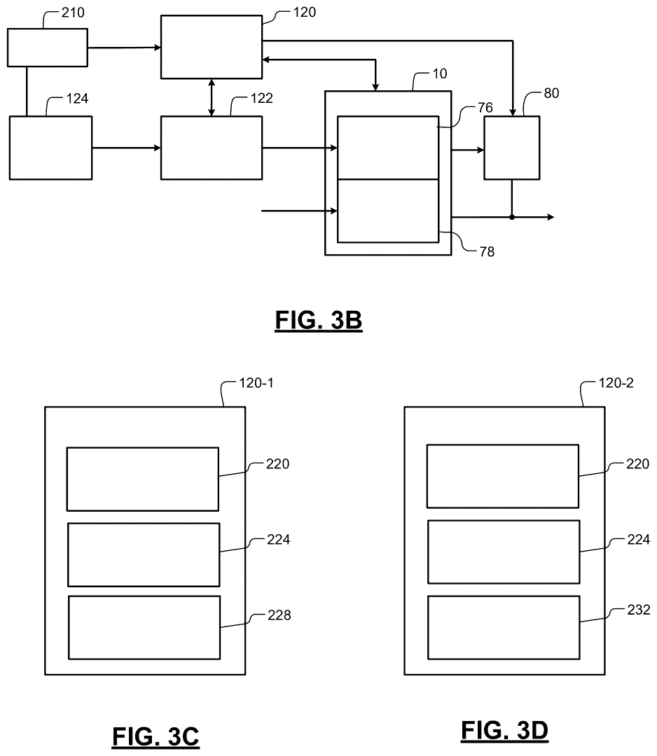

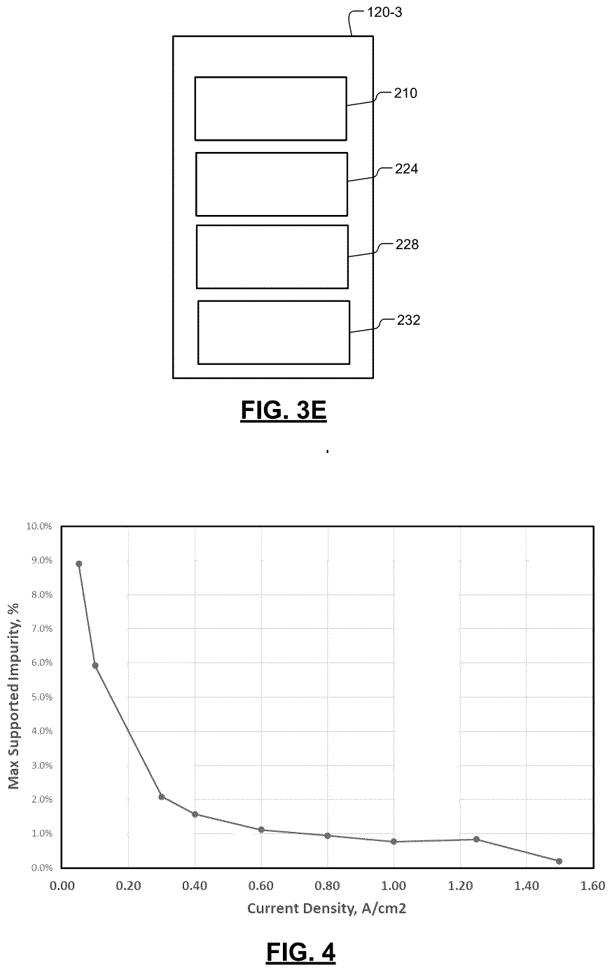

Referring now to FIGS. 3A and 3B, a fuel cell control system includes a controller 120 configured to control H₂ injectors 122 to supply H₂ fuel from a H₂ storage tank 124 to the anode 20 of the fuel cell stack 10. The controller 120 is configured to selectively open and close (and/or vary and opening of) the bleed valve 80 to adjust a bleed flow rate. Airflow is supplied to the cathodes of the fuel cell stack 10.

H₂ purity is used by the controller 120 to adjust operation of the fuel cell stack 10. In FIG. 3A, the controller 120 receives H₂ purity from an external source. Examples of the external source for the hydrogen purity include an operator inputting the hydrogen purity using an interface 134 of the vehicle. In some examples, the interface 134 is part of an infotainment system 130.

In other examples, the infotainment system 130 includes an application or app 132 that retrieves the hydrogen purity for the hydrogen filling station using a telematics system 136. The telematics system 136 wirelessly communicates with a server 140 and application or app 142 via a distributed communications system 144 (such as a wired or wireless local area network, the Internet, etc.). In some examples, the server 140 is remote and the connection is wireless. In other examples, the server 140 is located on premises and is wirelessly or directly connected to a vehicle data bus during refilling.

In some examples, the H₂ purity and amount of the H₂ fuel added along with the H₂ purity of the H₂ fuel and amount already in the H₂ storage tank are used to calculate a new H₂ purity of the H₂ fuel in the H₂ storage tank after filling.

In FIG. 3B, a hydrogen purity sensor 210 is used to measure the H₂ purity. In some examples, the hydrogen purity sensor 210 is arranged in the H₂ storage tank 124 and is configured to measure the resulting H₂ purity of the H₂ fuel in the H₂ storage tank 124.

In FIG. 3C, the controller 120-1 includes a maximum current density calculating module 220 configured to calculate the maximum current density jₘₐₓ. The controller 120 includes a maximum impurity calculator 224 configured to calculate the maximum impurity Pct_{Impurity_N2}. The controller 120-1 includes a maximum output power adjusting module 228 that reduces output of the fuel cell (e.g., reduces a load on the fuel cell) until higher purity H₂ fuel is available.

In FIG. 3D, the controller 120-2 includes a maximum current density calculating module 220 configured to calculate the maximum current density jₘₐₓ. The controller 120 includes a maximum impurity calculator 224 configured to calculate the maximum impurity Pct_{Impurity_N2}. The controller 120-2 includes a bleed valve adjusting module 232 that increases flow through the bleed valve until higher purity H₂ fuel is available.

In FIG. 3E, the controller 120-3 includes a maximum current density calculating module 220 configured to calculate the maximum current density jₘₐₓ. The controller 120 also includes a maximum impurity calculator 224 configured to calculate the maximum impurity Pct_{Impurity_N2}. The controller 120-3 includes the maximum output power adjusting module 228 and the bleed valve adjusting module 232 to allow additional control freedom when adjusting operation to accommodate lower purity H₂ fuel.

Referring now to FIG. 4, maximum supported impurity percentage is shown as a function of current density (in Amps/cm²) based on a set of assumptions using equation (8). As can be appreciated, the maximum supported impurity percentage decreases with increasing current density. In some examples, the controller 120 decreases the maximum current load output by the fuel cell as a function of or in response to decreases in H₂ purity of the H₂ fuel. In some examples, the controller 120 increases the maximum current load output by the fuel cell as a function of or in response to increases in H₂ purity of the H₂ fuel. In some examples, the controller 120 increase an opening of the bleed valve to compensate for decreases in H₂ purity of the H₂ fuel.

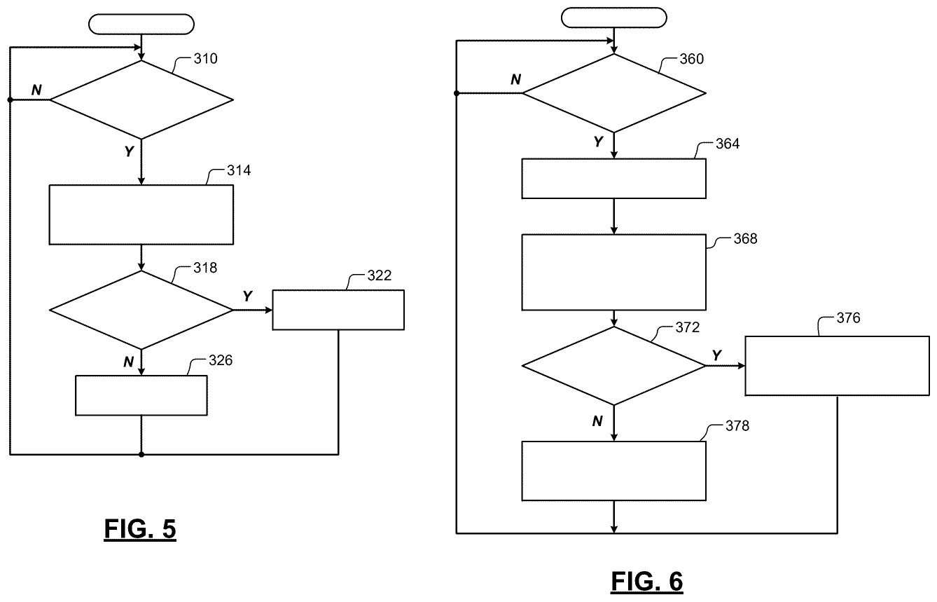

Referring now to FIGS. 5 to 9, examples of operation of the fuel cell stack in response to measured or received H₂ purity are shown. As can be appreciated, some or all of the aspects of the methods in FIGS. 5 to 9 can be combined with some or all of the aspects of other portions of the methods in FIGS. 5 to 9.

In FIG. 5, the method determines whether the H₂ storage tank is being filled at 310. At 314, the method receives the H₂ purity of the H₂ fuel from a remote device, a purity sensor, and/or an operator. If the H₂ fuel purity is greater than a first purity threshold TH₁ at 318, the controller enables filling of the H₂ fuel tank at 322. In some examples, the method opens a valve and/or sends an enabling message to the H₂ filling station. In some examples, the method requests the amount of H₂ fuel to be added and calculates a final H₂ purity of the H₂ fuel in the H₂ storage tank. If the H₂ fuel purity is not greater than the first purity threshold TH₁, the method disables filling of the H₂ fuel tank at 326.

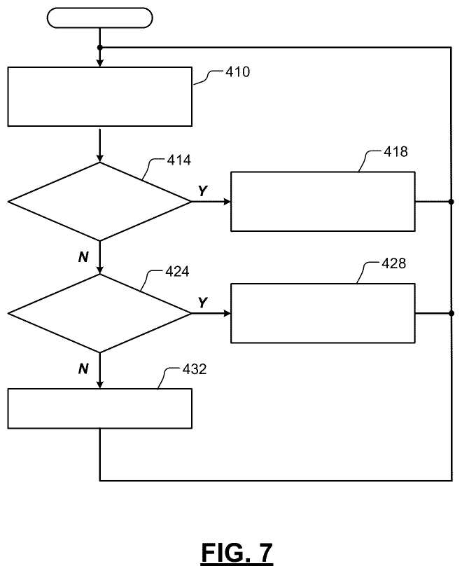

Referring now to FIG. 6, the method determines whether the H₂ storage tank is being filled at 360. At 364, the method receives the H₂ purity of the H₂ fuel from a remote device, a purity sensor, and/or an operator. In some examples, the method requests the amount of H₂ fuel to be added and calculates a final H₂ purity of the H₂ fuel in the H₂ storage tank at 368. If the H₂ fuel purity is less than a second purity threshold TH₂, the method adjusts maximum output power in response to the H₂ fuel purity at 376. If the H₂ fuel purity is greater than a second purity threshold TH₂, the method does not adjust maximum output power at 378.

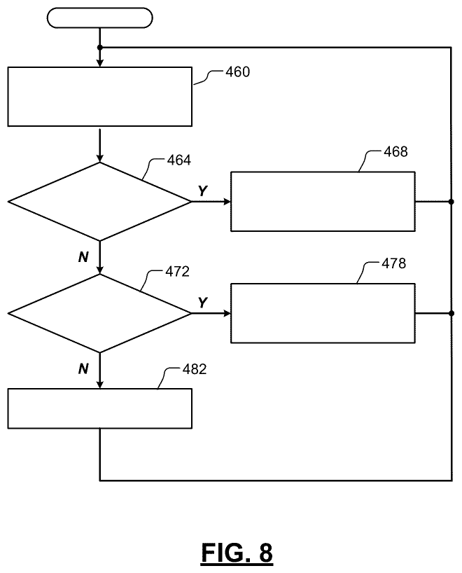

Referring now to FIG. 7, the H₂ purity of the H₂ fuel in the H₂ storage tank is measured using a hydrogen purity sensor at 410. At 414, the method determines whether the H₂ purity is greater than a third threshold TH₃. If 414 is true, the method operates the fuel cell stack at maximum power at 418. If 414 is false, the method determines whether the H₂ purity is greater than a fourth threshold TH₄ at 424. If 424 is true, the method adjusts maximum power output in response to the measured H₂ purity at 428. If 424 is false, the method stops operation at 432.

Referring now to FIG. 8, the H₂ purity of the H₂ fuel in the H₂ storage tank is measured using a sensor at 460. At 464, the method determines whether the H₂ purity is greater than a third threshold TH₃. If 464 is true, the method operates the fuel cell stack at maximum power at 468. If 464 is false, the method determines whether the H₂ purity is greater than a fourth threshold TH₄ at 472. If 474 is true, the method adjusts a position of the bleed valve or operating duty cycle of the bleed valve in response to the measured H₂ purity at 478. If 474 is false, the method does not adjust the position of the bleed valve at 482.

The present disclosure provides enhanced control of H₂ concentration at the anode in response to H₂ fuel purity as an input. The controller avoids fuel cell stack H₂ starvation and the corresponding reduction in durability of the fuel cell stack due to low purity H₂ fuel. The control system avoids fuel cell power generation crash/interruption due to low purity H₂ fuel. The control system can be used to estimate the maximum supportable fuel cell system power based on H₂ fuel purity.

In some examples, the fuel cell system selectively accepts or rejects the H₂ fuel from the H₂ filling station based on the H₂ fuel purity at startup of the fuel filling station system.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A fuel cell system, comprising:
a fuel cell stack including:
an anode electrode;
a first gas diffusion layer arranged adjacent to the anode electrode;
a cathode electrode;
a second gas diffusion layer arranged adjacent to the cathode electrode; and
a proton exchange membrane (PEM) arranged between the anode electrode and the cathode electrode;
one or more hydrogen injectors configured to inject hydrogen fuel into the first gas diffusion layer; and
a controller configured to receive a hydrogen purity of the hydrogen fuel and to selectively adjust operation of the fuel cell system in response thereto.

2. The fuel cell system of claim 1, further comprising a hydrogen purity sensor configured to measure the hydrogen purity of the hydrogen fuel and outputs the hydrogen purity to the controller.

3. The fuel cell system of claim 1, wherein the controller receives the hydrogen purity from an external source.

4. The fuel cell system of claim 1, wherein the controller includes a maximum current density calculating module configured to calculate a maximum current density.

5. The fuel cell system of claim 4, wherein the controller includes a maximum impurity calculating module configured to calculate a maximum impurity of the hydrogen fuel.

6. The fuel cell system of claim 5, wherein the controller includes a maximum power adjusting module configured to adjust a maximum output power of the fuel cell stack in response to at least one of the maximum current density and the maximum impurity of the hydrogen fuel.

7. The fuel cell system of claim 5, further comprising a bleed valve in fluid communication with an anode volume.

8. The fuel cell system of claim 7, wherein the controller includes a bleed valve adjusting module configured to adjust flow through the bleed valve in response to at least one of the maximum current density and the maximum impurity of the hydrogen fuel.

9. The fuel cell system of claim 7, wherein the controller includes:
a maximum power adjusting module configured to selectively adjust a maximum output power of the fuel cell stack in response to at least one of the maximum current density and the maximum impurity of the hydrogen fuel; and
a bleed valve adjusting module configured to selectively adjust flow through the bleed valve in response to at least one of the maximum current density and the maximum impurity of the hydrogen fuel.

10. A vehicle comprising the fuel cell system of claim 1.

11. A fuel cell system, comprising:
a fuel cell stack including:
an anode electrode;
a first gas diffusion layer arranged adjacent to the anode electrode and defining an anode volume;
a cathode electrode;
a second gas diffusion layer arranged adjacent to the cathode electrode; and
a proton exchange membrane (PEM) arranged between the anode electrode and the cathode electrode;
one or more hydrogen injectors configured to inject hydrogen fuel into the first gas diffusion layer;
a bleed valve in fluid communication with the anode volume of the first gas diffusion layer; and
a controller configured to receive a hydrogen purity of the hydrogen fuel and to at least one of selectively reduce a maximum output power of the fuel cell stack and increase flow through the bleed valve in response to changes in the hydrogen purity.

12. The fuel cell system of claim 11, further comprising a hydrogen purity sensor configured to measure the hydrogen purity of the hydrogen fuel and outputs the hydrogen purity to the controller.

13. The fuel cell system of claim 11, wherein the controller receives the hydrogen purity from an external source.

14. The fuel cell system of claim 11, wherein the controller includes a maximum current density calculating module configured to calculate a maximum current density.

15. The fuel cell system of claim 14, wherein the controller includes a maximum impurity calculating module configured to calculate a maximum impurity of the hydrogen fuel.

16. The fuel cell system of claim 15, wherein the controller includes a maximum power adjusting module configured to adjust a maximum output power of the fuel cell stack in response to at least one of the maximum current density and the maximum impurity of the hydrogen fuel.

17. The fuel cell system of claim 15, wherein the controller includes a bleed valve adjusting module configured to adjust flow through the bleed valve in response to at least one of the maximum current density and the maximum impurity of the hydrogen fuel.

18. The fuel cell system of claim 15, wherein the controller includes a maximum power adjusting module configured to selectively adjust a maximum output power of the fuel cell stack in response to at least one of the maximum current density and the maximum impurity of the hydrogen fuel.

19. The fuel cell system of claim 15, wherein the controller includes a bleed valve adjusting module configured to selectively adjust flow through the bleed valve in response to at least one of the maximum current density and the maximum impurity of the hydrogen fuel.

20. A vehicle comprising the fuel cell system of claim 11.
